(19) United States
(12) Patent Application Publication
(10) Pub. No.: US 2018/0280816 A1
(43) Pub. Date: Oct. 4, 2018

(54) Motor Driven Horse Simulacrum Vehicle

(71) Applicant: Dale Acker, Nazareth, TX (US)

(72) Inventor: Dale Acker, Nazareth, TX (US)

(21) Appl. No.: 15/923,188

(22) Filed: Mar. 16, 2018

Related U.S. Application Data
(60) Provisional application No. 62/477,670, filed on Mar. 28, 2017.

(51) Int. Cl. A63G 31/00; B62D 63/02; B62D 1/22; B60L 11/18; B60L 15/00; B60L 15/20

(52) U.S. Cl. CPC A63G 31/00; B62D 63/02; B62D 1/22; A63G 2200/00; B60L 15/007; B60L 15/20; B60L 11/1877

(57) ABSTRACT

A device for giving carriage rides without having a live horse. A chassis has a steering wheel and a pair of rear drive wheels. The chassis is hooked to a carriage by a yoke. A user can steer the chassis by a reign connected to the steering wheel via a steering assembly including a steering tube, a steering headset and a fork tube. The chassis is powered by a motor. In the present embodiment, the motor is an electrical motor operably connected to a battery. A platform is disposed on the chassis, wherein a set of simulacrum horses are disposed on the platform, giving the carriage the appearance of being drawn by horses.

### CROSS REFERENCE TO RELATED APPLICATIONS

This application claims the benefit of U.S. Provisional Application No. 62/477,670 filed on Mar. 28, 2017. The above identified patent application is herein incorporated by reference in its entirety to provide continuity of disclosure.

### BACKGROUND OF THE INVENTION

The present invention relates to motorized carriages. Specifically, the present invention relates to carriages pulled by a motorized chassis.

Tourists and sightseers often choose to go on animal drawn carriage rides but over the course of time it has become increasingly difficult to keep and care for such animals. Costs of room, board and veterinary care can be high, especially later in an animal's life when it may not be able to perform as well as when it was younger. Thus, there is a need for a carriage with the same aesthetic appeal as a horse drawn carriage but is driven by a motor instead.

Several devices are known to address this need. One such device is a horse statue that is configured to be connected to a motorized carriage at a rear end of the horse statue. This device teaches that the horse statute has a front end that may pivot left or right, thus steering the motorized carriage via the horse statue. However, this device fails to disclose a motorized chassis connected to a carriage, wherein the chassis has a horse simulacrum thereon.

### SUMMARY OF THE INVENTION

In view of the foregoing disadvantages inherent in the known types of motor driven carriages now present in the known art, the present invention provides a motor driven horse simulacrum vehicle wherein the same can be utilized for providing convenience for the user when a traditional horse drawn carriage is provided. The present system comprises a carriage affixed to a chassis by a yoke, wherein the chassis draws the carriage. The chassis has a turning wheel at a front-end portion and a pair of drive wheels affixed to an axle on opposing ends of the axle, wherein the axle is rotated by a motor connected to a power source, such as an electric motor connected to a battery. A steering assembly is fastened to the turning wheel, thereby allowing a user on the carriage to steer the chassis with a reign.

One object of the present invention is to provide a motor driven horse simulacrum vehicle having a chassis with a motor and a horse simulacrum disposed on the chassis.

Another object of the present invention is to provide a motor driven horse simulacrum vehicle having a chassis with an electric motor, wherein the electric motor is operably connected to a battery and is configured to rotate an axle having a pair of wheels thereon.

Yet another object of the present invention is to provide a motor driven horse simulacrum vehicle wherein the carriage is pulled by a chassis having a horse simulacrum thereon and is steered by reigns operably connected to a turning wheel rotably affixed to the chassis.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the motor driven horse simulacrum vehicle.

FIG. 2. shows a perspective view of the rear end portion of the chassis of an embodiment of the motor driven horse simulacrum vehicle.

FIG. 3 shows an alternate perspective view from a front end of an embodiment of the motor driven horse simulacrum vehicle.

### DETAILED DESCRIPTION OF THE INVENTION

Reference is made herein to the attached drawings. Like reference numerals are used throughout the drawings to depict like or similar elements of the motor driven horse simulacrum vehicle. The figures are intended for representative purposes only and should not be considered to be limiting in any respect. Unless specifically limited to a single unit, “a” is intended to be equivalent to “one or more” throughout the present disclosure.

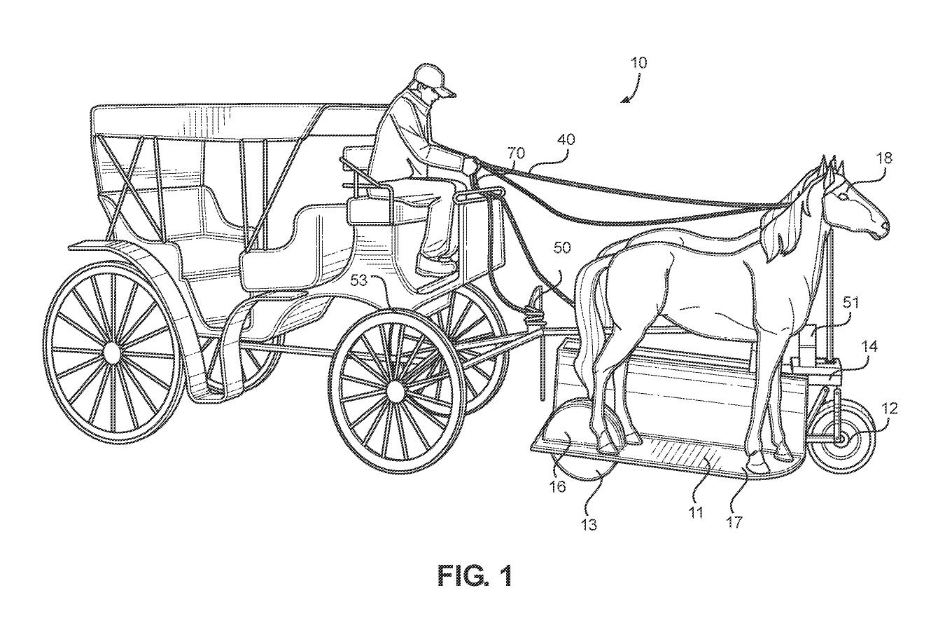

Referring now to FIG. 1, there is shown a perspective view of an embodiment of the motor driven horse simulacrum vehicle. The motor driven horse simulacrum vehicle 10 comprises a chassis 11 connected to a carriage 53, wherein the chassis 11 draws the carriage 53. The speed of the chassis 11 and carriage 53 is adjustable by a controller 90, wherein the controller 90 is disposed on the carriage 53 within arm's reach of the carriage driver. The chassis 11 has a turning wheel 12 and a pair of rear drive wheels 13 affixed to an axle. The turning wheel 13 is pivotally affixed to a front-end portion 14 of the chassis 11. The rear drive wheels 13 are positioned at a rear end portion 16 of the chassis 11, wherein the axle is affixed to the chassis 11 by a bearing, allowing the axle to freely rotate. In one embodiment, the turning wheel 12 is a rubber wheel. In the illustrated embodiment, the chassis 11 is a triangle, wherein the triangle tapers toward the front-end portion 14 of the chassis 11.

A platform 17 is secured atop the chassis 11. The platform 17 supports a pair of horse simulacrums 18 thereon, wherein the horse simulacrums 17 are disposed on either side of the turning wheel 12. In the illustrated embodiment, the horse simulacrums 18 are aluminum horse statutes. In other embodiments, the simulacrums 18 may not take on the appearance of horses, e.g. the simulacrums may be reindeer or headless horsemen.

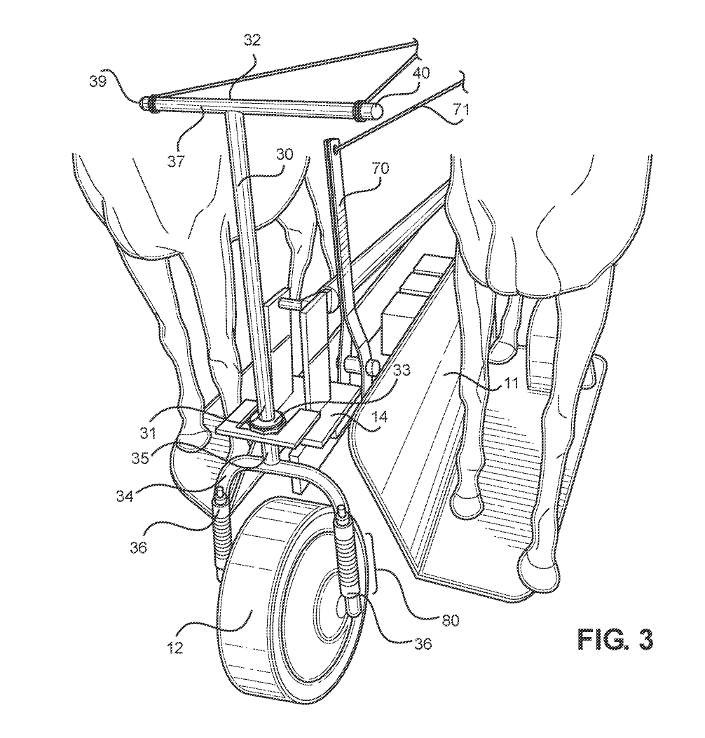

The carriage 53 is secured to the chassis 11 by a yoke 50. In the shown embodiment, the yoke 50 includes an elongated member having a first end 51 of the yoke 50 is pivotally affixed to the front-end portion 14 of the chassis 11. Additionally, a second end 52 of the yoke 50 is pivotally affixed to the carriage 11, wherein the first end 51 of the yoke 50 pivots about a lateral axis parallel to the axle and the back end pivots about a longitudinal axis perpendicular to the axle. In one embodiment, the yoke 50 includes a rope cleat extending therefrom, wherein the rope cleat provides a securement point of a reign (as shown in FIG. 3).

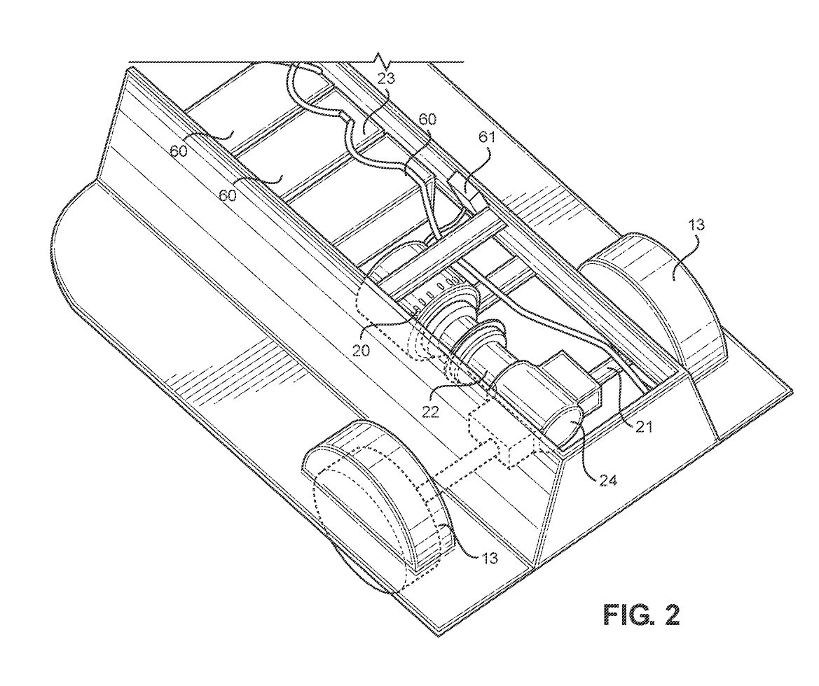

Now referring to FIG. 2, there is shown a perspective view of the rear end portion of the chassis of an embodiment of the motor driven horse simulacrum vehicle. A motor 20 powers the chassis 11, wherein the motor 20 is operably connected to a power source 23. The motor 20 operably connects to the axle 21, wherein the motor 20 is configured to rotate the axle 21. In the present embodiment, the motor 20 is an electric motor and the power source 23 is a battery 60. In this embodiment, the motor is a 12 v, 10 horsepower electric motor and the power source 23 is a plurality of batteries 60, which may be rechargeable batteries. Further, the batteries 60 of the plurality of batteries 60 are electrically connected to the motor 20 in series.

In the illustrated embodiment, the motor 20 rotates a drive shaft 22, which in turn, rotates the axle 21. The drive shaft 22 rotates about an axis perpendicular to the axis of rotation of the axle 21, thus the drive shaft 21 is operably connected to the axle 21 by a differential unit 24. The differential unit 24 rotates the direction of the rotational force output by the driveshaft 22 ninety degrees and supplies that rotated rotational force to the axle 21.

To control the power provided to the axle 21 by the motor 20, an inverter 61 is operably connected to the battery 60 and the motor 20, wherein the inverter 61 is situated between the battery 60 and the motor 20. The inverter 61 regulates the electric current provided to the motor 20 from the battery 60, thereby regulating the speed at which the motor 20 rotates the axle 21. In the illustrated embodiment, the intensity of the electric current output from the inverter 61 is controlled by the controller 90 disposed on the carriage 53, as seen in FIG. 1. In the shown embodiment, the rear wheels 13 are disposed within wheel wells of the platform. The rear wheels 13 are inboard a lateral edge of the platform.

Now referring to FIG. 3, there is shown an alternate perspective view from a front end of an embodiment of the motor driven horse simulacrum vehicle. A steering assembly is fastened to the turning wheel 12 of the chassis 11. In the present embodiment, the steering assembly includes a steering tube 30 having a bottom end 31 opposed to a top end 32. The bottom end 31 is secured to a steering headset 33, wherein the steering headset 33 is disposed in the front-end portion 14 of the chassis 11. The steering tube 30 extends upwards from the steering headset 33. At the top end 32 of the steering tube 30 a crossbar 37 is disposed. The crossbar 37 is perpendicular to the steering tube 30 and extends bidirectionally outward in equivalent lengths from the top end 32. The crossbar 37 has a pair of opposing ends 39, 38, wherein the reign 40 is fastened to the crossbar 37 at each of the ends 38, 39. This configuration allows a carriage driver to steer the chasses 11 in a way similar to that of steering a yoked horse, i.e. by applying a force to a side of the reign to steer the horse in that direction.

A fork tube 34 connects the turning wheel 12 to the steering headset 33. The fork tube 34 has a stem 35 that splits into a pair of arm members 36. The stem 35 is secured to the steering headset 33, and thereby is connected to the steering tube 30. The pair of arm members 36 are rotably connected to the turning wheel 12, allowing the turning wheel 12 to freely roll. In the shown embodiment, the pair of arms 36 are suspension rods. The suspension rods in this embodiment are spring suspension rods 80.

In the illustrated embodiment, a brake 70 is disposed on the chassis. A brake cable 71 connects the brake 70 to a driver of the carriage, wherein the driver can pull the brake cable 71 to slow the carriage and chassis 11. The brake 70 can be any brake that slows the carriage and chassis 11, such as a friction brake, wherein the brake applies a frictional force to a ground surface or wheels of the chassis 11.

In the shown embodiment, the platform includes a pair of outwardly facing benches each have an upstanding member forming a gap therebetween. The gap houses the power supply and battery therein. The turning wheel 12 extends past an open front end of the gap formed by the pair of outwardly facing benches. In this way, the turning wheel 12 is adapted to rotate at sharp angles without interference from the platform.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A motor driven horse simulacrum vehicle, comprising:
a chassis having a turning wheel and a pair of rear drive wheels, wherein the turning wheel is pivotally affixed to a front-end portion of the chassis and the pair of rear drive wheels is disposed on an axle at a rear end portion of the chassis;
a motor operably connected to a power source, wherein the motor is configured to rotate the axle;
a platform secured to the chassis, wherein a simulacrum of a horse is secured atop the platform;
a steering assembly having a reign operably connected to the turning wheel, wherein the reign pivots the turning wheel when selectively actuated.

2) The motor driven horse simulacrum vehicle of claim 1, wherein the motor is an electric motor.

3) The motor driven horse simulacrum vehicle of claim 2, wherein the power source is a battery.

4) The motor driven horse simulacrum vehicle of claim 3, wherein an inverter is operably connected to the battery and the electric motor, wherein the inverter regulates the electric current provided to the electric motor from the battery, thereby regulating the speed of the electric motor, wherein the inverter is controlled by a controller disposed on the carriage.

5) The motor driven horse simulacrum vehicle of claim 3, wherein a plurality of batteries is operably connected to the motor in series.

6) The motor driven horse simulacrum vehicle of claim 1, wherein:
the steering assembly further comprises a steering tube having a bottom end opposed a top end, wherein the reign is affixed to the top end of the steering tube;
wherein the bottom end of the steering tube is affixed to a steering headset disposed within the front-end portion of the chassis;
wherein a fork tube having a stem and a pair of arm members is affixed to the steering headset on the stem of the fork tube and is rotably affixed to the steering wheel on the pair of arm members.

7) The motor driven horse simulacrum vehicle of claim 6, wherein a crossbar is disposed on the top end of the steering rod and the crossbar has a pair of opposing ends, wherein the reign is affixed to the crossbar at the pair of opposing ends.

8) The motor driven horse simulacrum vehicle of claim 1, wherein a brake is disposed on the chassis, wherein a brake cable selectively actuates the brake when the brake cable is pulled by a user.

9) The motor driven horse simulacrum vehicle of claim 1, wherein the steering wheel is rubber.

10) The motor driven horse simulacrum vehicle of claim 1, wherein the axle is operably connected to the motor via a driveshaft and a differential unit, wherein the drive shaft is perpendicular to the axle and the differential unit rotates the force output by the motor, through the driveshaft ninety degrees to drive the axle.

11) The motor driven horse simulacrum vehicle of claim 1, wherein each arm of the fork tube is a suspension rod.

12) The motor driven horse simulacrum vehicle of claim 1, further comprising a yoke pivotally affixed at a first end to the chassis and configured to pivotally affix at a second end to a carriage.

13) The motor driven horse simulacrum vehicle of claim 12, wherein the first end of the yoke pivots about a lateral axis parallel to the axle and the second end pivots about a longitudinal axis perpendicular to the axle.

14) The motor driven horse simulacrum vehicle of claim 1, wherein:
the platform comprises a pair of outwardly facing benches each have an upstanding member forming a gap therebetween, the gap housing the motor.
